(19) United States
(12) Patent Application Publication
(10) Pub. No.: US 2021/0213474 A1
(43) Pub. Date: Jul. 15, 2021

(54) WATER SPRINKLER DANCE COSTUME AND METHOD OF USE

(71) Applicant: Eric Le Blanc, Murrieta, CA (US)

(72) Inventor: Eric Le Blanc, Murrieta, CA (US)

(21) Appl. No.: 16/742,792

(22) Filed: Jan. 14, 2020

(51) Int. Cl. B05B 12/08; H04R 1/02; B05B 11/00; H04R 3/00; G08B 7/06; A41D 1/00

(52) U.S. Cl. CPC B05B 12/08; H04R 1/028; B05B 11/30; H04R 2201/023; G08B 7/06; A41D 1/002; H04R 3/00

(57) ABSTRACT

Embodiments of the invention relate to a water sprinkler dance costume. More particularly, the present invention relates to and involves a live water spraying costume to be worn by children and/or adults having functional components that mimic a water sprinkler upon activation while performing a water sprinkler dance. Further, the present invention pertains to a motorize pump assembly coupled to the liquid housing, a power supply providing power to the motorize pump assembly, a water flow controller coupled to the motorize pump assembly, a water dispense tube coupled to the liquid housing, and a trigger switch coupled to the motorize pump assembly, wherein the trigger switch controls the activation and deactivation of the motorize pump assembly for dispensing the water out of the exit water port.

### FIELD OF THE INVENTION

The present invention relates to a water sprinkler dance costume. More particularly, the present invention relates to and involves a live water spraying costume to be worn by children and/or adults having functional components that mimic a water sprinkler upon activation while performing a water sprinkler dance.

### BACKGROUND

Costumes for Halloween and masquerade parties are abundantly available and have been around for quite some time. For example, some of these costumes may include fictional super heroes and villains, animals, as well as other creative imaginary characters. Though many types of these costumes and designs exist for the purpose of mimicking the appearance of real or imaginary characters, most do not have features or functionality that provides live action responses and synchronization to specific events or specialized dance movements. Therefore, there is a need for an enhanced and interactive costuming to provide costume apparel having functional elements which when triggered are capable of activating electrical and mechanical components, enhancing the visual appearance and interactive feel of the costume used in some specialized dance crazes.

### SUMMARY

One object of this invention is to provide a water sprinkler dance costume for mimicking a functional and live water sprinkler while performing a water sprinkler dance, the water sprinkler dance costume having a wearable garment having two sleeve portions; a water control chamber attached to an inner portion of the wearable garment, the water control chamber includes a liquid housing for holding water; a motorize pump assembly coupled to the liquid housing; a power supply providing power to the motorize pump assembly; a water flow controller coupled to the motorize pump assembly, having circuitry for controlling the motorize pump assembly; a water dispense tube coupled to the liquid housing for delivering the water from the liquid housing to an exit water port placed near an arm opening of one of the sleeves; and a trigger switch coupled to the motorize pump assembly, the trigger switch controls the activation and deactivation of the motorize pump assembly for dispensing the water out of the exit water port.

Another object of this invention is to provide a method of performing a water sprinkler dance by a user wearing a water sprinkler dance costume, the method including putting on and wearing the water sprinkler dance costume by the user, the water sprinkler dance costume comprises a wearable garment having two sleeve portions; a water control chamber attached to an inner portion of the wearable garment, the water control chamber includes a liquid housing for holding water; a motorize pump assembly coupled to the liquid housing; a power supply providing power to the motorize pump assembly; a water flow controller coupled to the motorize pump assembly, having circuitry for controlling the motorize pump assembly; a water dispense tube coupled to the liquid housing for delivering the water from the liquid housing to an exit water port placed near an arm opening of one of the sleeves; and a trigger switch coupled to the motorize pump assembly, the trigger switch controls the activation and deactivation of the motorize pump assembly for dispensing the water out of the exit water port; lifting one arm nearly perpendicular to the body of the user wearing the water sprinkler dance costume with the exit water port coupled to the lifted arm; moving the lifted arm in a side-to-side and up-and-down motion, emulating a water sprinkler; and actuating the motorize pump assembly via the trigger switch controlling the activation and deactivation of the motorize pump assembly for dispensing the water out of the exit water port, and simulating a live water sprinkler.

These and other objects, features and advantages of the present invention will become more apparent in light of the following detailed description of preferred embodiments thereof, as illustrated in the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 illustrates a water sprinkler dance costume worn by a user for mimicking a functional water sprinkler while performing a water sprinkler dance craze, according to an embodiment.

FIG. 2 illustrates the water sprinkler dance costume having lights and sound accessories, according to another embodiment.

FIG. 3 illustrates the water sprinkler dance costume having a hoodie attached to the neck of the garment wearable garment, according to another embodiment.

FIG. 4 illustrates a short sleeve implementation of the water sprinkler dance costume, according to another embodiment.

FIG. 5 illustrates the water sprinkler dance costume having a functional and head-mounted lawn sprinkler, according to another embodiment.

FIG. 6 illustrates the water sprinkler dance costume having multiple water dispensing stations, according to another embodiment.

FIG. 7 illustrates an alternative trigger switch configuration of the water sprinkler dance costume, according to an embodiment.

FIG. 8 illustrates optional components for securing the non-functional/functional head-mounted lawn sprinkler of the water sprinkler dance costume, according to an embodiment.

FIG. 9 illustrates the non-functional/functional head-mounted lawn sprinkler attached to the top of a hat, according to an embodiment.

FIG. 10 illustrates a block diagram of the water flow controller, according to an embodiment.

FIG. 11 illustrates a block diagram of the LED light and audio controller, according to an embodiment.

FIG. 12 illustrates a first method of performing the water sprinkler dance while wearing the water sprinkler dance costume, according to an embodiment.

FIG. 13 illustrates a second method of performing the water sprinkler dance while wearing the water sprinkler dance costume, according to an embodiment.

FIG. 14 illustrates a third method of performing the water sprinkler dance while wearing the water sprinkler dance costume, according to an embodiment.

FIG. 15 illustrates suggested arm movements executed by the user while performing the water sprinkler dance and wearing the water sprinkler dance costume, according to an embodiment.

### DETAILED DESCRIPTION

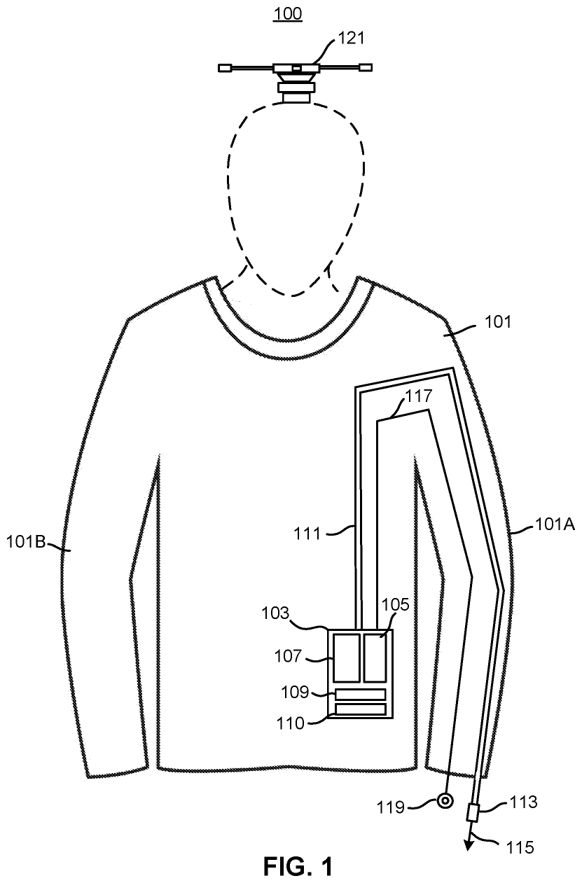

FIG. 1 illustrates a water sprinkler dance costume 100 worn by a user for mimicking a functional water sprinkler while performing a water sprinkler dance craze, according to an embodiment. The water sprinkler dance costume 100 may include a wearable garment 101 such as a pull-over shirt having two long sleeve portions 101A, 101B, and a water control chamber 103 attached to an inner portion of the wearable garment 101. The water control chamber 103 includes a liquid housing 105 for holding water or other type of liquids, a motorize pump assembly 107 coupled to the liquid housing 105, a power supply 109 (e.g., rechargeable battery) coupled and providing power to the motorize pump assembly 107, and a water flow controller 110 having circuitry for controlling the motorize pump assembly 107. A water dispense tube 111 is coupled to the liquid housing 105 to deliver the water from the liquid housing 105 to an exit water port 113 placed near an arm opening of one of the sleeves 101A. A trigger switch 119 is coupled to the motorize pump assembly 107 via electrical wire 117, controlling the activation/deactivation of the motorize pump assembly 107 for dispensing the water out of the exit water port 113. In practice, both the exit water port 113 and the trigger switch 119 are located near the hand of the user for easy access and control of the switch 119 and for directing the exit water port 113 to a desired direction. The exit port 113 may include a water spray nozzle assembly for providing low, medium or high water spray in an outward direction 115, projecting away from the user's hand when in operation. In practice, the user may control the activation of the water spray by depressing the trigger switch 119 during certain dance movements such as while the arm is fully extended and nearly perpendicular to the body, moving from side-to-side, mimicking a water sprinkler. To further enhance the visual appearance of the costume 100, a non-functional head-mounted lawn sprinkler 121 may be included with the costume and worn on the user's head. In another implementation, the exit port 113 may be disposed on any portion of the sleeves or in the chest area of the wearable garment 101. In yet another implementation, the wearable garment 101 may include wearable articles such as a firefighter's uniform, a vest, a suit, active wear or military uniforms.

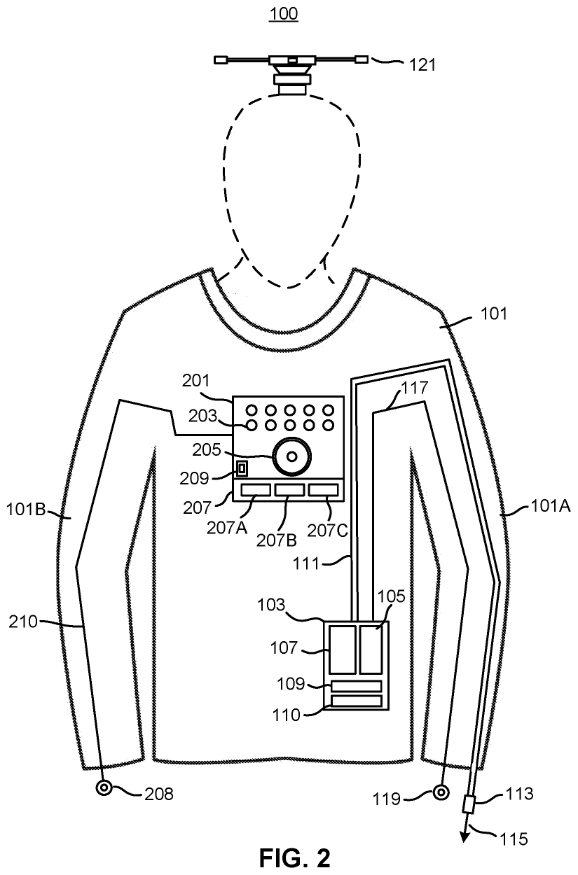

FIG. 2 illustrates the water sprinkler dance costume 100 having lights and sound accessories, according to another embodiment. In this example, the water sprinkler dance costume 100 may also include lights and sound accessories 201 attached to a front side and near a middle portion of the wearable garment 101, including, for example, a plurality of lights 203, a speaker 205, and an LED Light and audio controller 207 for controlling the lights and delivering sound to the speaker 205. The LED Light and audio controller 207 may include separate control units such as a light controller unit 207A, a sound controller unit 207B, and a movement detection unit 207C. In another embodiment, the LED Light and audio controller 207 may be implemented by a portable computing device such as a smartphone, personal digital assistant (PDA) or miniature computer board. Optionally, the lights and sound accessories 201 may include a microphone 209 for receiving audio input commands from the user. The LED Light and audio controller 207 may also include a microprocessor and memory for executing and storing software programming instructions to control light activity and sound such as music or special audio effects. In another implementation, the LED Light and audio controller 207 may be coupled to an AV switch 208 via wire 210 for manually activating or deactivating the lights and sounds generated by the LED Light and audio controller 207.

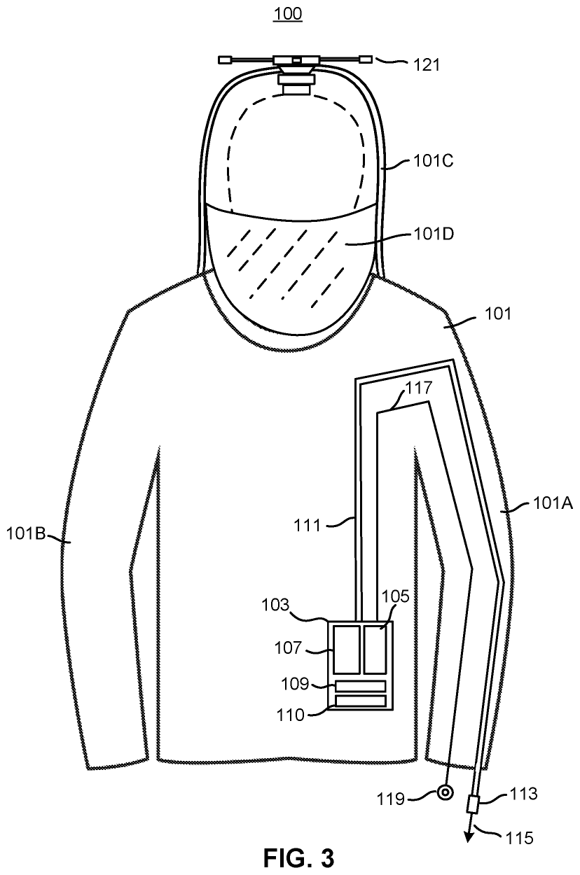

FIG. 3 illustrates the water sprinkler dance costume 100 having a hoodie 101C attached to the neck of the garment wearable garment 101, according to another embodiment. The hoodie 101C may be covered with a waterproof fabric for preventing water from making contact to the user's head. In another implementation, the water sprinkler dance costume 100 may include a face mask 101D coupled to the hoodie 101C for covering and protecting the user's face from any discharged water. In practice, the hoodie 101C and face mask 101D may be made from natural or synthetic fabrics such as Nylon, Polyester, laminated cotton, poplin, oilcloth, polyester fleece, microfiber, and wool having waterproofing and/or water resistant properties.

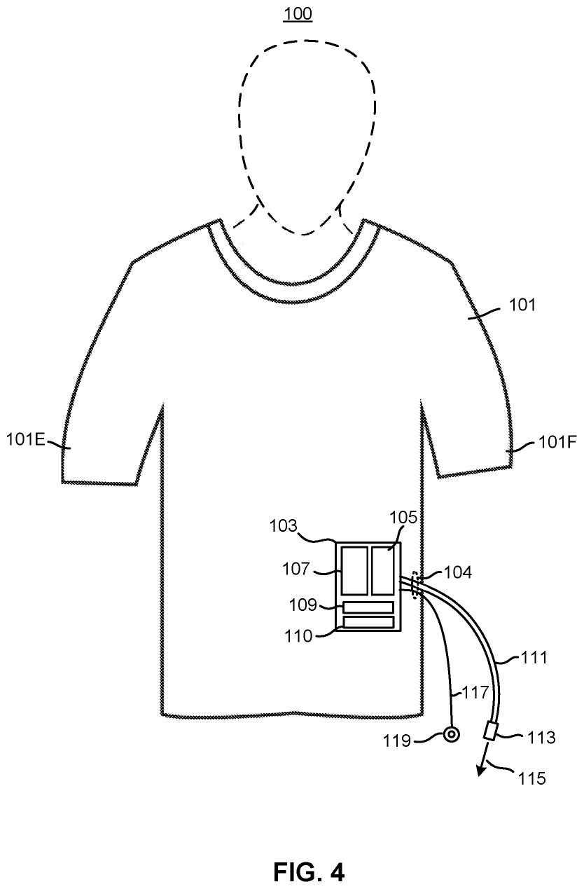

FIG. 4 illustrates a short sleeve implementation of the water sprinkler dance costume 100, according to another embodiment. In the short sleeve implementation, the water sprinkler dance costume 100 may include the wearable garment 101 such as the pull-over shirt having two short sleeve portions 101E, 101F, and the water control chamber 103 attached to the inner portion of the wearable garment 101. The water control chamber 103 includes the liquid housing 105 for storing water or other type of liquids, the motorize pump assembly 107 coupled to the liquid housing 105, the power supply 109 (e.g., rechargeable battery) coupled and providing power to the motorize pump assembly 107, and the water flow controller 110 having circuitry for controlling the motorize pump assembly 107. The water dispense tube 111 is coupled to the liquid housing 105 to deliver the water from the liquid housing 105 to the exit water port 113. In the short sleeve implementation, a portion of the water dispense tube 111 is passed through an opening or hole 104 formed in the garment 101 allowing it to be near the user's hand when the arm is fully extended. The trigger switch 119 is coupled to the motorize pump assembly 107 via the electrical wire 117 having a portion of the wire 117 also inserted through the hole 104 of the garment 101 so that the switch 119 is near the user's hand when the arm is fully extended. In operation, the trigger switch 119 is configured to control the activation/deactivation of the motorize pump assembly 107 for dispensing the water out of the exit water port 113.

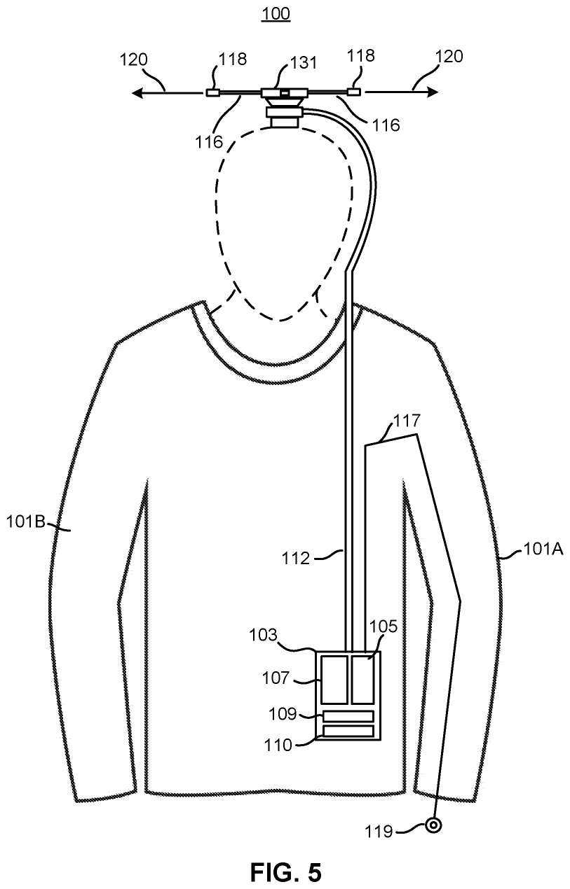

FIG. 5 illustrates the water sprinkler dance costume 100 having a functional and head-mounted lawn sprinkler 131, according to another embodiment. In this implementation, the functional and head-mounted lawn sprinkler 131 may be coupled to a sprinkler water dispense tube 112 allowing water to be transmitted from the water control chamber 103 to multiple water dispense arms 116 of the sprinkler water dispense tube 112. In addition, each water dispense arm 116 may include an exit water port 118 (e.g., spray nozzle) coupled to a distal end of each water dispense arm 116. In operation, the user may press/depress the trigger switch 119 to control the activation/deactivation of the motorize pump assembly 107 for dispensing the water out of the multiple output dispense arms 116 through exit water ports 118. In this implementation, the exit ports 118 may include a water spray nozzle assembly for providing low, medium or high water spray in different outward directions 120, projecting away from the user's head when in operation. In one implementation, the multiple output dispense arms 116 may be stationary, projecting the water in a fixed direction relative to the user's head. In another implementation, the multiple output dispense arms 116 may be coupled to a rotating base, allowing the multiple output dispense arms 116 to freely spin upon activation of the trigger switch 119, projecting the water along a 360 degree direction relative to the user's head.

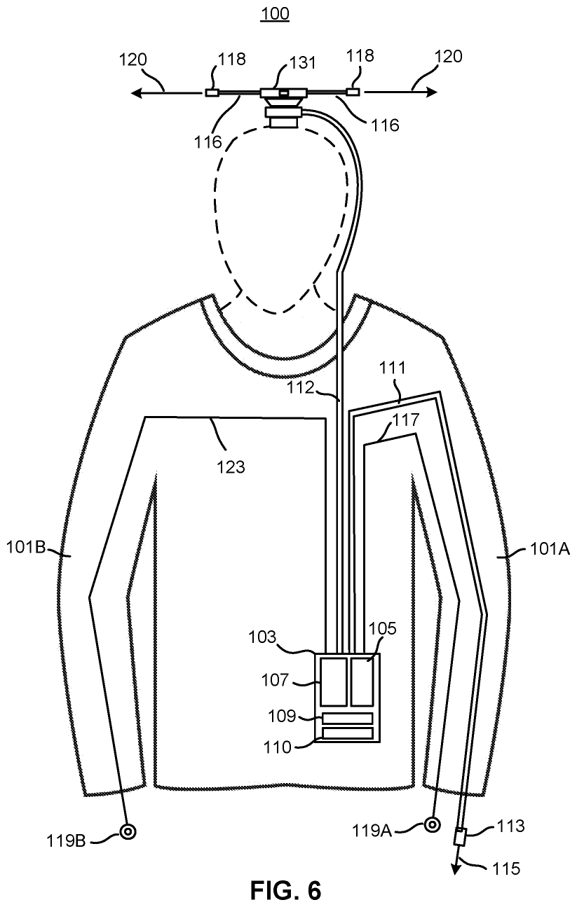

FIG. 6 illustrates the water sprinkler dance costume 100 having multiple water dispensing stations, according to another embodiment. In this implementation, the water sprinkler dance costume 100 may include the wearable garment 101 such as the pull-over shirt having two long sleeve portions 101A, 101B, and the water control chamber 103 attached to the inner portion of the wearable garment 101. The water control chamber 103 includes the liquid housing 105 for holding water or other type of liquids, the motorize pump assembly 107 coupled to the liquid housing 105, the power supply 109 (e.g., rechargeable battery) coupled and providing power to the motorize pump assembly 107, and the water flow controller 110 having circuitry for controlling the motorize pump assembly 107. A first water dispense tube 111 is coupled to the liquid housing 105 to deliver the water from the liquid housing 105 to the exit water port 113 placed near the arm opening of one of the sleeves 101A. A second water dispense tube 112 is coupled to the liquid housing 105 to deliver the water from the liquid housing 105 to the functional and head-mounted lawn sprinkler 131, allowing water to be transmitted from the water control chamber 103 to multiple water dispense arms 116 of the head-mounted lawn sprinkler 131. In the multiple water dispensing stations, a first trigger switch 119A is coupled to the motorize pump assembly 107 via electrical wire 117, controlling the activation/deactivation of the motorize pump assembly 107 for dispensing the water out of the exit water port 113, while a second trigger switch 119B is coupled to the motorize pump assembly 107 via electrical wire 123, controlling the activation/deactivation of the motorize pump assembly 107 for dispensing the water out of the exit ports 118. In practice, the first trigger switch 119A may be located near a first hand of the user (along long sleeve portions 101A) for easy access and control of the switch 119A and for directing the exit port 113 to the desired direction, while the second trigger switch 119B is located near the other hand of the user for easy access and control of the switch 119 for controlling the activation/deactivation of the motorize pump assembly 107 for dispensing the water out of the exit ports 118.

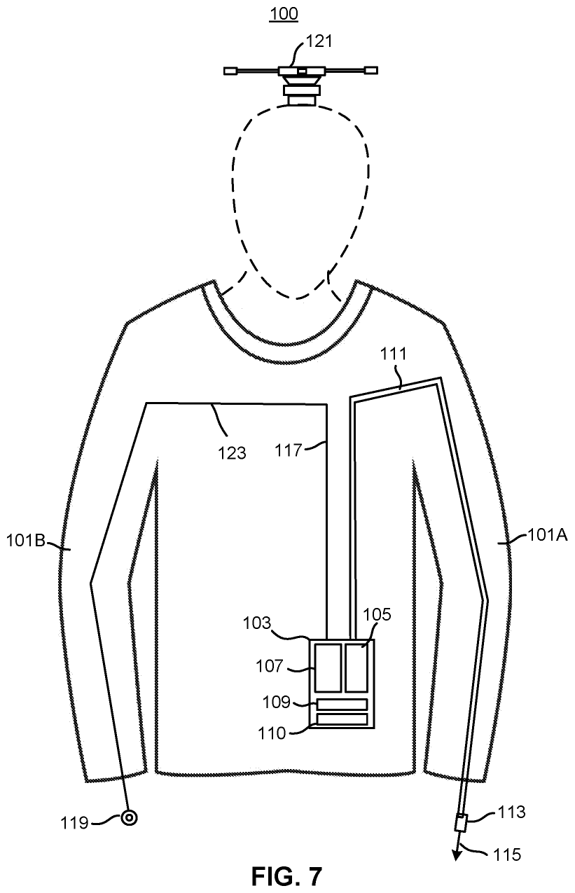

FIG. 7 illustrates an alternative trigger switch configuration of the water sprinkler dance costume 100, according to an embodiment. In the alternative trigger switch configuration, the water sprinkler dance costume 100 may include the wearable garment 101 having two long sleeve portions 101A, 101B, and the water control chamber 103 attached to the inner portion of the wearable garment 101. The water control chamber 103 may include the liquid housing 105 for holding water or other type of liquids, the motorize pump assembly 107 coupled to the liquid housing 105, the power supply 109 coupled and providing power to the motorize pump assembly 107, and the water flow controller 110 having circuitry for controlling the motorize pump assembly 107. The water dispense tube 111 may be coupled to the liquid housing 105 to deliver the water from the liquid housing 105 to the exit water port 113 placed near the arm opening of the first sleeves 101A. In the alternative trigger switch configuration, the trigger switch 119B may be disposed on the second sleeve 101B and coupled to the motorize pump assembly 107 via electrical wire 123, controlling the activation/deactivation of the motorize pump assembly 107 for dispensing the water out of the exit water port 113. In practice, the alternative trigger switch configuration allows the user to enable/disable the motorize pump assembly 107 with the hand of the second arm sleeve 101B while simultaneously dispensing and directing the water spray at the exit port 113 with the other hand of the first arm sleeve 101A, providing the user additional control and movement of their arms while performing the water sprinkler dance craze.

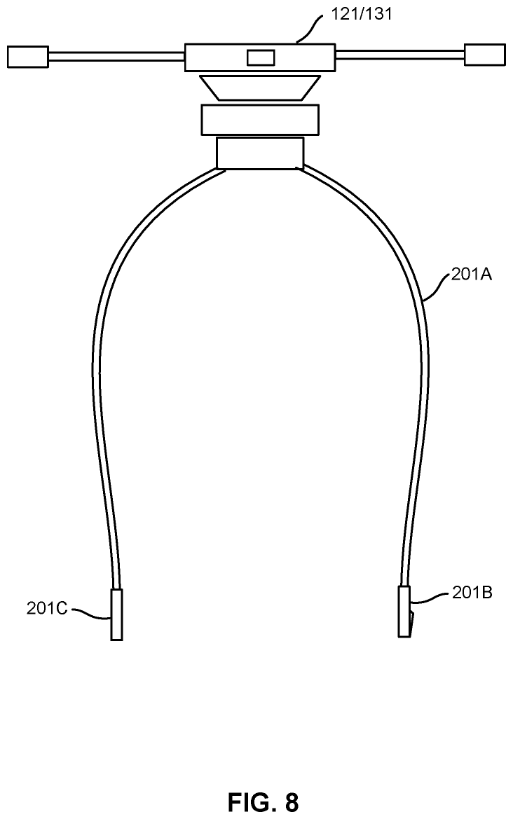

FIG. 8 illustrates optional components for securing the non-functional/functional head-mounted lawn sprinkler 121/131 of the water sprinkler dance costume 100, according to an embodiment. In one implementation, the non-functional/functional head-mounted lawn sprinkler 121/131 may be secured the head of the user using a strap 201A and fasteners 2013/201C. Examples of straps 201A may include nylon, rubber, polyester, corded, polypropylene, and other composite synthetic materials, while fasteners 2013/201C may include quick release buckles, cam buckles, ratchet buckles, roller buckles, slide buckles, and snap buckles.

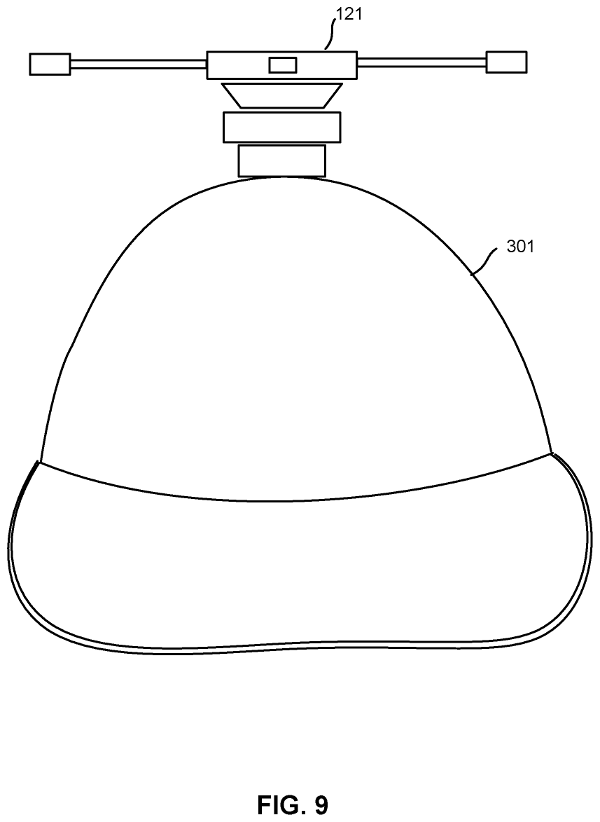

FIG. 9 illustrates the non-functional/functional head-mounted lawn sprinkler 121/131 attached to the top of a hat 301, according to an embodiment. This implementation allows the user to easily wear and remove the non-functional/functional head-mounted lawn sprinkler 121/131 without the encumbrances of having to attach and properly center the non-functional/functional head-mounted lawn sprinkler 121/131 to the top of the head of the user.

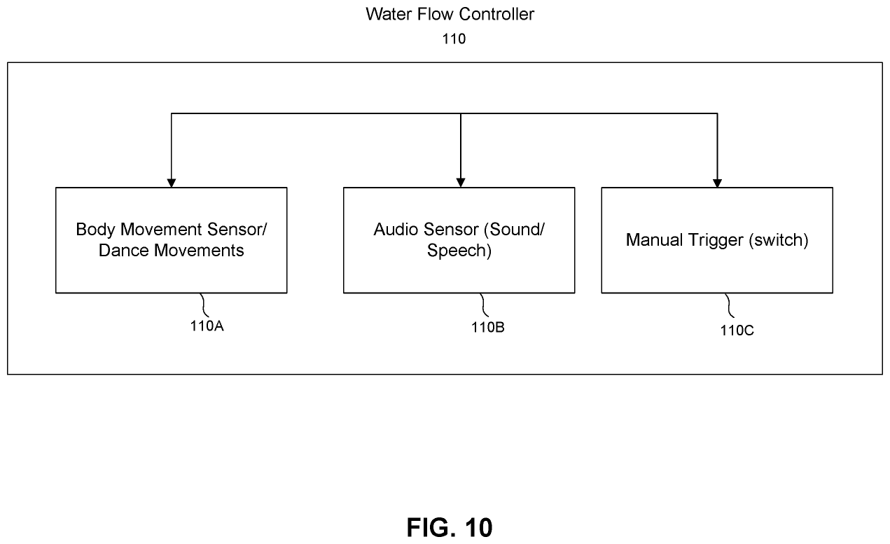

FIG. 10 illustrates a block diagram of the water flow controller 110, according to an embodiment. In operation, the water flow controller 110 is configured to control the operation of the motorize pump assembly 107 of the water sprinkler dance costume 100 using electrical and mechanical trigger mechanisms, including, for example, a body movement sensor 110A, an audio sensor 110B, or a switch 110C. In one implementation, the body movement sensor 110A may include devices such as accelerometers, inertial sensors, and magnetic bearing sensors. In another implementation, the audio sensor 110B may include devices such as acoustic pressure sensors, pressure microphones, high amplitude pressure microphones, pre-polarized condenser microphones, high amplitude pressure microphones, probe microphones, condenser microphones & pre-polarized free-field condenser microphones. In yet in another implementation, the switch 110C may include either a mechanical switch or an electrical switch. In practice, the water flow controller 110 may automatically adjust the actuation and volume of water dispensed by the motorize pump assembly 107 based on inputs from the body movement sensor 110A or audio sensor 110B while the user is performing the certain dance movement of the water sprinkler dance. For example, when an increase in motion activity of the user is detected by the body movement sensor 110A, the water flow controller 110 may automatically increase the actuation and volume of water dispensed by the motorize pump assembly 107, spraying more water out of nozzle at the exit water port 113. Conversely, when a decrease in motion activity of the user is detected by the body movement sensor 110A, the water flow controller 110 may automatically decrease the actuation and volume of water dispensed by the motorize pump assembly 107, spraying less water out of nozzle at the exit water port 113. Similarly, when an increase in environmental sound intensity (such as voice or music) is detected by the audio sensor 110B, the water flow controller 110 may automatically increase the actuation and volume of water dispensed by the motorize pump assembly 107, spraying more water out of nozzle at the exit water port 113. Likewise, when an increase in environmental sound intensity is detected by the audio sensor 110B, the water flow controller 110 may automatically decrease the actuation and volume of water dispensed by the motorize pump 107, spraying less water out of nozzle. The water flow controller 110 may include electrical circuit components including, for example, a microprocessor, memory, storage, and digital components that control the operation of the motorize pump assembly 107 based on electrical or digital inputs from the body movement sensor 110A, the audio sensor 110B, or the switch 110C. In addition, the water flow controller 110 may include software programming code stored in memory that instructs the operation of the motorize pump assembly 107 based on these electrical or digital inputs.

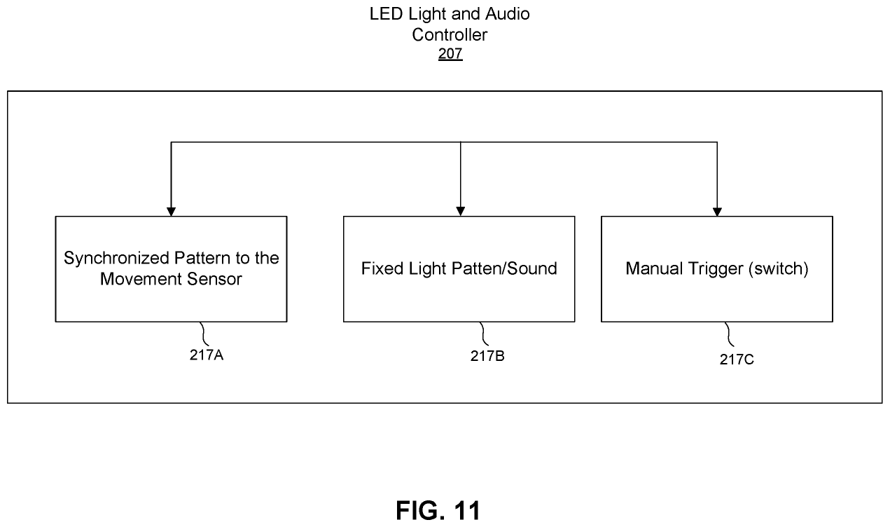

FIG. 11 illustrates a block diagram of the LED light and audio controller 207, according to an embodiment. In one implementation, the LED light controller and audio controller 207 may include multiple operating modes controlling the operation of the plurality of lights 203 and audio from the speaker 205, including, for example, 1) a dynamic or synchronized mode 217A which causes the activation/deactivation of the lights and/or sound based on movements detected by the movement detection unit 207C; 2) a fixed mode 217B that generates a predetermined pattern of lights and sounds; and 3) manual triggered mode 217C which allows the user to determine the activation and deactivation of the lights and sound using the AV switch 208. In another implementation, the LED light controller and audio controller 207 may include speech recognition hardware and software controlling the activation and deactivation the lights and sounds based on audio commands from the user through the microphone 209. The movement detection unit 207C may include sensors such as accelerometers, inertial sensors, and magnetic bearing sensors. The microphone 209 may include devices such as acoustic pressure sensors, pressure microphones, high amplitude pressure microphones, pre-polarized condenser microphones, high amplitude pressure microphones, probe microphones, condenser microphones & pre-polarized free-field condenser microphones. The AV switch 208 may include either a mechanical switch or an electrical switch. In practice, the various operating modes of the LED light and audio controller 207 may enhance the visual appearance of the water sprinkler dance costume 100 worn by the user while he or she is performing the water sprinkler dance, providing a unique performance to one or more spectators.

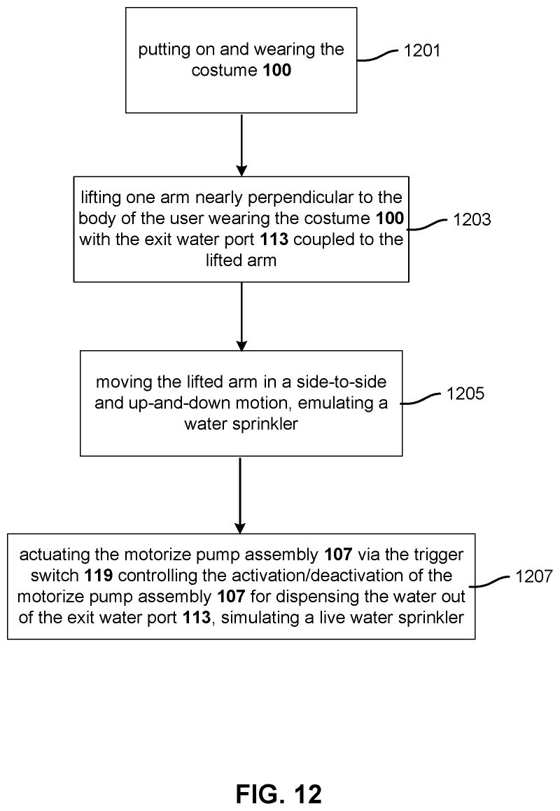

FIG. 12 illustrates a first method of performing the water sprinkler dance while wearing the water sprinkler dance costume 100, according to an embodiment. One dance performance by a user may include the steps of 1) putting on and wearing the costume 100 by the user (step 1201); 2) lifting one arm nearly perpendicular to the body of the user wearing the costume 100 with the exit water port 113 coupled to the lifted arm (step 1203); 3) moving the lifted arm in a side-to-side and up-and-down motion, emulating a water sprinkler (step 1205); 4) actuating the motorize pump assembly 107 via the trigger switch 119 controlling the activation/deactivation of the motorize pump assembly 107 for dispensing the water out of the exit water port 113, and simulating a live water sprinkler (step 1207).

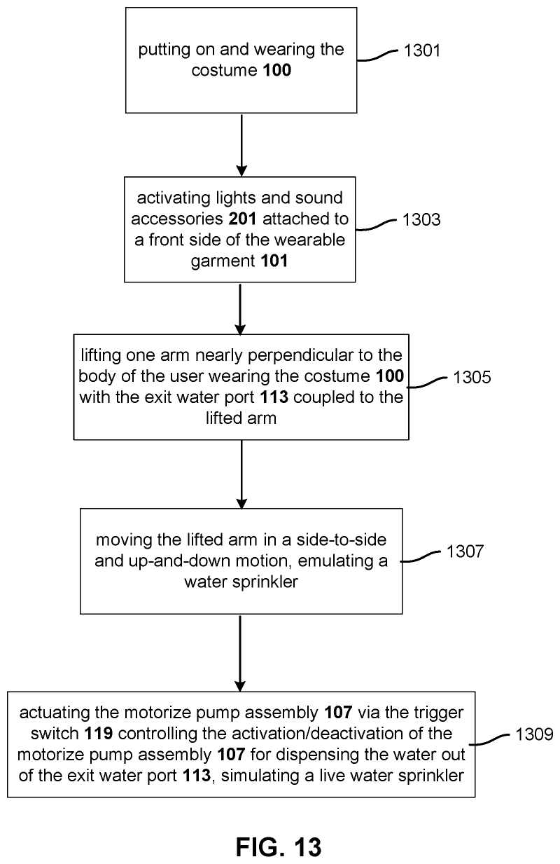

FIG. 13 illustrates a second method of performing the water sprinkler dance while wearing the water sprinkler dance costume 100, according to an embodiment. Another dance performance by the user may include the steps of 1) putting on and wearing the costume 100 by the user (step 1301); 2) activating lights and sound accessories 201 attached to a front side of the wearable garment 101 (step 1303); 3) lifting one arm nearly perpendicular to the body of the user wearing the costume 100 with the exit water port 113 coupled to the lifted arm (step 1305); 4) moving the lifted arm in a side-to-side and up-and-down motion, emulating a water sprinkler (step 1307); 5) actuating the motorize pump assembly 107 via the trigger switch 119 controlling the activation/deactivation of the motorize pump assembly 107 for dispensing the water out of the exit water port 113, and simulating a live water sprinkler (step 1309).

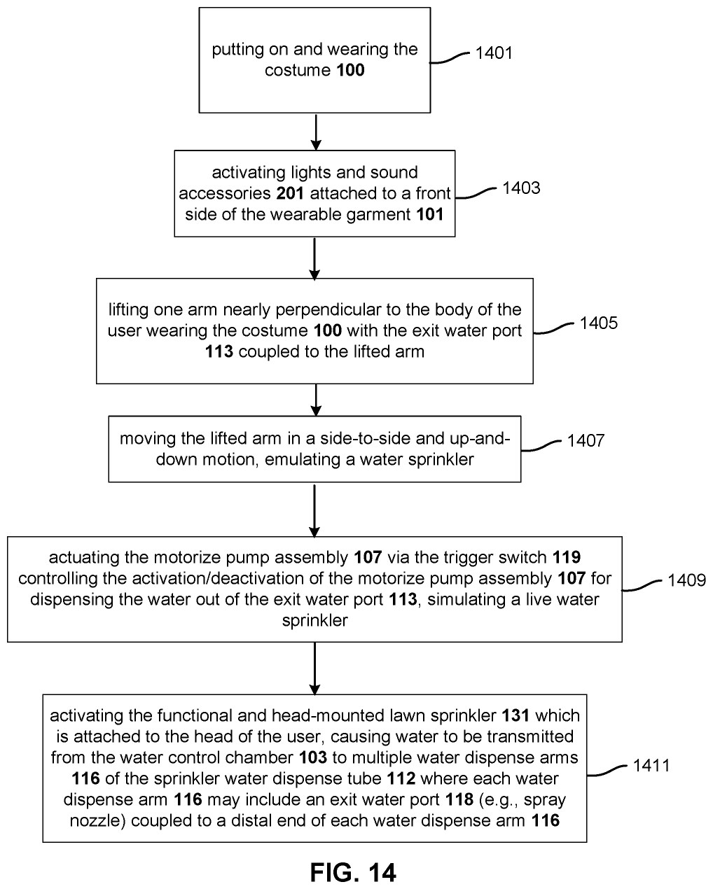

FIG. 14 illustrates a third method of performing the water sprinkler dance while wearing the water sprinkler dance costume 100, according to an embodiment. Another dance performance by the user may include the steps of 1) putting on and wearing the costume 100 by the user (step 1401); 2) activating lights and sound accessories 201 attached to the wearable garment 101 (step 1403); 3) lifting one arm nearly perpendicular to the body of the user wearing the costume 100 with the exit water port 113 coupled to the lifted arm (step 1405); 4) moving the lifted arm in a side-to-side and up-and-down motion, emulating a water sprinkler (step 1407); 5) actuating the motorize pump assembly 107 via the trigger switch 119 controlling the activation/deactivation of the motorize pump assembly 107 for dispensing the water out of the exit water port 113, and simulating a live water sprinkler (step 1409); 6) activating the functional and head-mounted lawn sprinkler 131 which is attached to the head of the user, causing water to be transmitted from the water control chamber 103 to multiple water dispense arms 116 of the sprinkler water dispense tube 112 where each water dispense arm 116 may include an exit water port 118 (e.g., spray nozzle) coupled to a distal end of each water dispense arm 116 (step 1411).

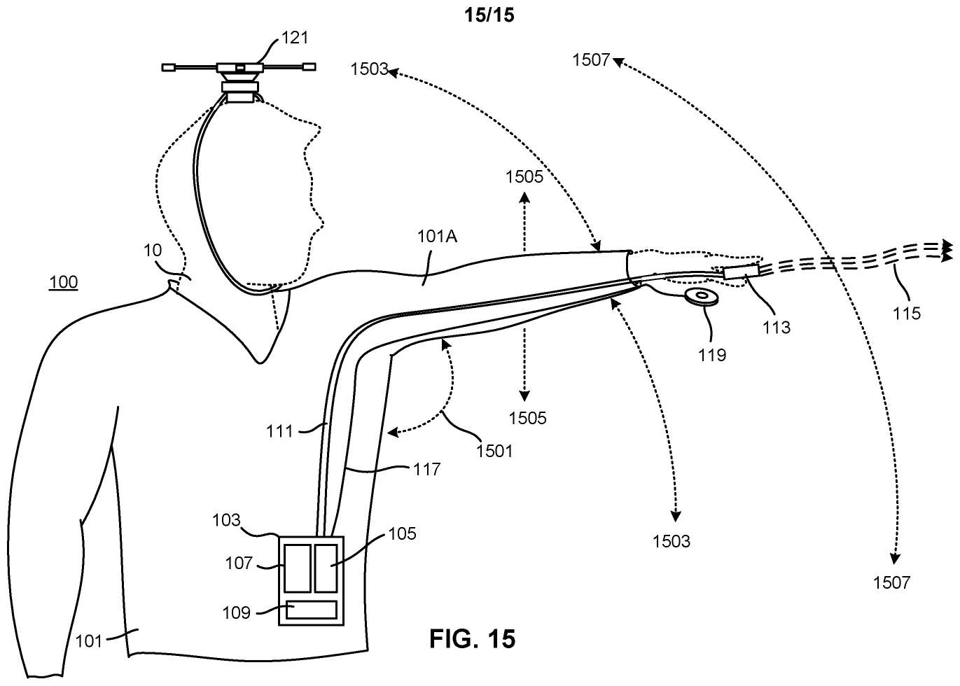

FIG. 15 illustrates suggested arm movements executed by the user while performing the water sprinkler dance and wearing the water sprinkler dance costume 100, according to an embodiment. During the water sprinkler dance performance, the user 10 may occasionally lift the arm that has the sleeve portion 101A coupled to the exit water port 113 in a nearly perpendicular manner relative to their body 1501. With the arm positioned nearly perpendicular to the body, the user 10 may move it in a side-to-side 1503 and up-and-down 1505 motion. While the arm is in motion, the user 10 may operate the motorize pump assembly 107 via the trigger switch 119, controlling the activation/deactivation of the motorize pump assembly 107 for dispensing the water out of the exit water port 113, and simulating a live water sprinkler. During operation of the motorize pump assembly 107, water is dispensed and sprayed in a wave-like fashion 1507, projected in an outward direction 115 away from the user 10.

In an alternative embodiment, the water sprinkler dance costume 100 may include other types of safe liquids instead of water such as soap, foam, fragrance scented liquids, or colored liquids. In another alternative embodiment, the water sprinkler dance costume 100 may include a partial or full body suit with printed or sewn images or text of a water sprinkler. In yet another embodiment, the trigger switch 119 may be wireless coupled to the motorize pump assembly 107 via RF wireless components, wirelessly controlling the activation/deactivation of the motorize pump assembly 107 for dispensing the water out of the exit water port 113.

As used in the specification and the appended claims, the singular forms “a”, “an”, and “the” included plural referents unless the context clearly dictates otherwise.

The foregoing disclosure has been provided merely for the purpose of explanation and is in no way to be construed as limiting of the present invention. Although the present invention has been shown and described with respect to several preferred embodiments thereof, various changes, omissions, and additions to the form and detail thereof, may be made therein, without departing from the spirit and scope of the invention. It is understood that the words which have been used herein are words of description and illustration, rather than words of limitation. Changes may be made, within the purview of the appended claims, as presently stated and as amended, without departing from the scope and spirit of the present invention in its aspects.

Other embodiments and modifications of the present invention may occur to those of ordinary skill in the art in view of these teachings. Accordingly, the invention is to be limited only by the following claims which include all other such embodiments and modifications when viewed in conjunction with the above specifications and accompanying drawings.

What is claimed is:

1. A water sprinkler dance costume for mimicking a functional and live water sprinkler while performing a water sprinkler dance, the water sprinkler dance costume comprising:
a wearable garment having two sleeve portions;
a water control chamber attached to an inner portion of the wearable garment, wherein the water control chamber includes a liquid housing for holding water;
a motorize pump assembly coupled to the liquid housing;
a power supply providing power to the motorize pump assembly;
a water flow controller coupled to the motorize pump assembly, having circuitry for controlling the motorize pump assembly;
a water dispense tube coupled to the liquid housing for delivering the water from the liquid housing to an exit water port; and
a trigger switch coupled to the motorize pump assembly, wherein the trigger switch controls the activation and deactivation of the motorize pump assembly for dispensing the water out of the exit water port.

2. The water sprinkler dance costume of claim 1, wherein the exit water port includes a water spray nozzle assembly for providing low, medium or high water spray.

3. The water sprinkler dance costume of claim 1 further comprising a non-functional head-mounted lawn sprinkler.

4. The water sprinkler dance costume of claim 1, wherein the water flow controller includes a body movement sensor, an audio sensor, or a switch for triggering the motorize pump assembly and controlling a flow of water dispensed at the exit water port.

5. The water sprinkler dance costume of claim 4, wherein the body movement sensor includes an accelerometer, an inertial sensor, or a magnetic bearing sensor.

6. The water sprinkler dance costume of claim 4, wherein the audio sensor includes acoustic pressure sensors, pressure microphones, high amplitude pressure microphones, pre-polarized condenser microphones, high amplitude pressure microphones, probe microphones, condenser microphones, or pre-polarized free-field condenser microphones.

7. The water sprinkler dance costume of claim 4, wherein the switch includes a mechanical switch or an electrical switch.

8. The water sprinkler dance costume of claim 1 further comprising lights and sound accessories attached to the wearable garment.

9. The water sprinkler dance costume of claim 8, wherein the lights and sound accessories include a plurality of lights, a speaker, and an LED light and audio controller for controlling the lights and delivering sound to the speaker.

10. The water sprinkler dance costume of claim 9, wherein the LED light and audio controller includes a light controller unit for controlling the plurality of lights, a sound controller unit for controlling an audio output to the speaker, and a movement detection unit for detecting body movements by a user wearing the water sprinkler dance costume.

11. The water sprinkler dance costume of claim 10, wherein the LED light and audio controller includes multiple operating modes controlling the operation of the plurality of lights and audio from the speaker.

12. The water sprinkler dance costume of claim 11, wherein the multiple operating modes include a synchronized mode for activating and deactivating the lights and/or sound based on dance movements detected by the movement detection unit; a fixed mode that generates a predetermined pattern of lights and sounds; and a manual triggered mode which allows the user to manually activate and deactivate the lights and sound using an AV switch.

13. The water sprinkler dance costume of claim 1 further comprising a hoodie coupled to a face mask for covering and protecting a face of a user from any discharged water.

14. The water sprinkler dance costume of claim 1, wherein the two sleeve portions are long sleeves.

15. The water sprinkler dance costume of claim 1, wherein the two sleeve portions are shorts sleeves.

16. The water sprinkler dance costume of claim 1 further comprising a functional head-mounted lawn sprinkler.

17. The water sprinkler dance costume of claim 1, wherein the water sprinkler dance costume includes a partial or full body suit having printed or sewn images or text of a water sprinkler.

18. A method of performing a water sprinkler dance by a user wearing a water sprinkler dance costume, the method comprising:
putting on and wearing the water sprinkler dance costume by the user, wherein the water sprinkler dance costume comprises a wearable garment having two sleeve portions; a water control chamber attached to an inner portion of the wearable garment, wherein the water control chamber includes a liquid housing for holding water; a motorize pump assembly coupled to the liquid housing; a power supply providing power to the motorize pump assembly;
a water flow controller coupled to the motorize pump assembly, having circuitry for controlling the motorize pump assembly; a water dispense tube coupled to the liquid housing for delivering the water from the liquid housing to an exit water port placed near an arm opening of one of the sleeves; and a trigger switch coupled to the motorize pump assembly, wherein the trigger switch controls the activation and deactivation of the motorize pump assembly for dispensing the water out of the exit water port;
lifting one arm nearly perpendicular to the body of the user wearing the water sprinkler dance costume with the exit water port coupled to the lifted arm;
moving the lifted arm in a side-to-side and up-and-down motion, emulating a water sprinkler; and
actuating the motorize pump assembly via the trigger switch controlling the activation and deactivation of the motorize pump assembly for dispensing the water out of the exit water port, and simulating a live water sprinkler.

19. The method of claim 18 further comprising activating lights and sound accessories attached to a front side of the wearable garment.

20. The method of claim 18 further comprising activating a functional and head-mounted lawn sprinkler which is attached to the head of the user, causing water to be transmitted from the water control chamber to multiple water dispense arms of a sprinkler water dispense tube, wherein each water dispense arm includes an exit water port coupled to a distal end of each water dispense.
